(19) United States
(12) Patent Application Publication
(10) Pub. No.: US 2018/0222241 A1
(43) Pub. Date: Aug. 9, 2018

(54) Combined Item Carrier and Greeting Card and Method of Forming Same

(71) Applicant: R. R. DONNELLEY & SONS COMPANY, Chicago, IL (US)

(72) Inventors: James B. Moriarty, Cary, NC (US); Andrew C. Charters, Raleigh, NC (US)

(21) Appl. No.: 15/889,805

(22) Filed: Feb. 6, 2018

Related U.S. Application Data
(60) Provisional application No. 62/455,022, filed on Feb. 6, 2017.

(51) Int. Cl. B42D 15/04; B65D 73/00

(52) U.S. Cl. CPC B42D 15/045; B65D 73/0085

(57) ABSTRACT

A combined item carrier and greeting card and a method of forming the same are disclosed in which a first panel includes a first portion and second portion joined along a first line of weakness, a second panel is joined to the first panel along a second line of weakness, and the first portion and the second portion are secured to one another to form a package to hold an item therebetween.

This present application claims benefit of Moriarty, U.S. Provisional Application 62/455,022, filed Feb. 6, 2017, entitled “Combined Item Carrier and Greeting Card” (Attorney Docket No. C7600/X229). The entire contents of this application are incorporated herein by reference.

### FIELD OF DISCLOSURE

The present subject matter relates to packaging for an item, and more particularly, to a combined item carrier and greeting card.

### BACKGROUND

Gift cards having a predetermined value are sold in various locations including pharmacies, grocery stores, gift shops and the like. Each gift card is typically attached to a gift card carrier and includes a unique identification number. To activate the gift card so that the gift card may be used for purchases, the purchaser or other recipient of the gift card may telephone a predetermined number associated with the gift card and enter the unique identification number. Alternatively, an online activation process may be used. Once activated, the unique identification number may be used in lieu of cash to make purchases at an online store, or the gift card may be presented to a cashier at a physical store. If presented at the physical store, the cashier at such store typically enters the unique identification number into a point-of-sale system for payment.

In some cases, because an activated gift card is essentially equivalent to cash, the gift card may be disposed in the gift card carrier such that the unique identification number is not exposed until after the gift card is purchased and removed from the carrier. In such situations, the gift card carrier may have to include an additional barcode or SKU number that is associated with the carrier, which must be entered into a point-of-sale system when the gift card is initially sold. However, if the gift card is stolen, the gift card may still be activated without the issuer having knowledge of the theft.

Further, if the purchaser of the typical gift card wishes to give the gift card as a present, the purchaser may have to purchase an additional greeting card to accompany the gift card. This requires the purchaser to undertake additional steps.

### SUMMARY

According to one aspect a combined item carrier and greeting card includes a first panel and a second panel. The first panel includes a first portion and a second portion joined along a first line of weakness, and the first panel and the second panel are joined along a second line of weakness. The first portion and the second portion are secured to one another to form a package to hold an item therebetween.

According to another aspect, a method of forming a combined item carrier and greeting card includes the steps of forming a first panel comprising a first portion and a second portion in a substrate and forming a second panel in the substrate. The first and second portions are joined along a first line of weakness and the second panel is joined to the first panel along a second line of weakness. The method includes the additional step of securing the first portion and the second portion to one another to form a package to hold an item therebetween.

### BRIEF DESCRIPTION OF THE DRAWINGS

FIG. 1 is an elevational view of a front exterior portion of a folded combined item carrier and greeting card;

FIG. 2 is an elevational view of a rear exterior portion of the folded combined item carrier and greeting card of FIG. 1;

FIG. 3 is an elevational view of the exterior of an opened combined item carrier and greeting card of FIG. 1;

FIG. 4 is an elevational view of an interior of the opened combined item carrier and greeting card of FIG. 1;

FIGS. 5-6 are elevational views of a substrate that may be used to form the combined greeting card and gift card carrier of FIG. 1;

FIG. 7 is an elevational view similar to FIG. 6 illustrated portions coated with adhesive and in combination with an item comprising a gift card;

FIG. 8 an elevational view of a rear exterior portion of another embodiment of the folded combined item carrier and greeting card;

FIG. 8A is an elevational view of a rear exterior portion of still another embodiment of the folded combined item carrier and greeting card;

FIG. 8B is an elevational view of a rear exterior portion of yet another embodiment of the folded combined item carrier and greeting card;

FIG. 9 is an elevational view of an exterior of an open combined item carrier and greeting card;

FIG. 10 is an elevational view of an interior of the open combined item carrier and greeting card of FIG. 9;

FIG. 11 is an elevational view of an exterior of an open combined item carrier and greeting card, wherein the greeting card has a plurality of panels;

FIG. 12 is an elevational view of an interior of the open combined item carrier and greeting card of FIG. 11; and

FIG. 13 is an elevational view of a panel of the greeting card of the combined item carrier and greeting card of FIG. 11.

### DETAILED DESCRIPTION

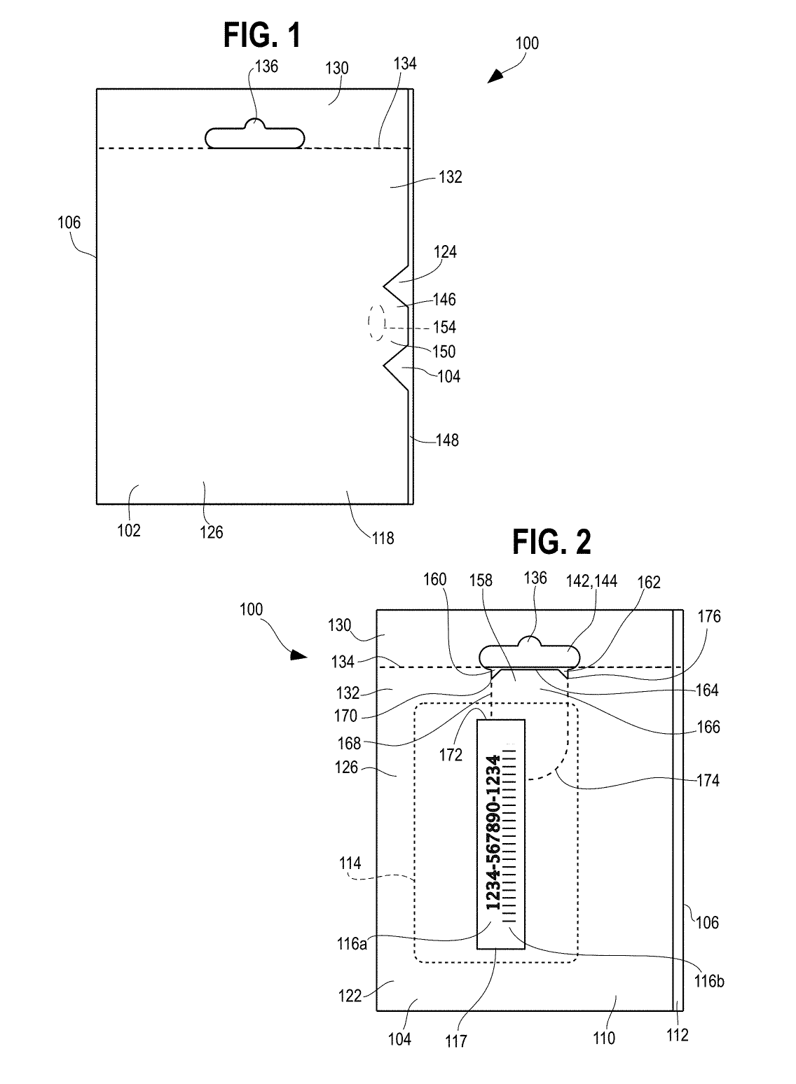

Referring to FIGS. 1-4, a combined item carrier and greeting card (carrier) 100 includes a greeting card (or front panel) 102 and an item carrier (or rear panel) 104 coupled to one another along an edge 106 formed along a fold line or line of weakness 108.

As described below, a first portion 110 and a second portion 112 of the rear panel 104 are secured to one another to form a secure package that holds a gift card or other item 114 therebetween. In some embodiments, a gift card or other item 114 may be disposed between the first portion 110 and the second portion 112 such that indicia 116 associated with the gift card 114 is exposed through a window 117 in the first portion 110, and thereby through the rear panel 104. Such indicia 116 may be identification information associated with the gift card 114 including, for example, a unique identification number 116a and/or a unique barcode 116b, and/or the like.

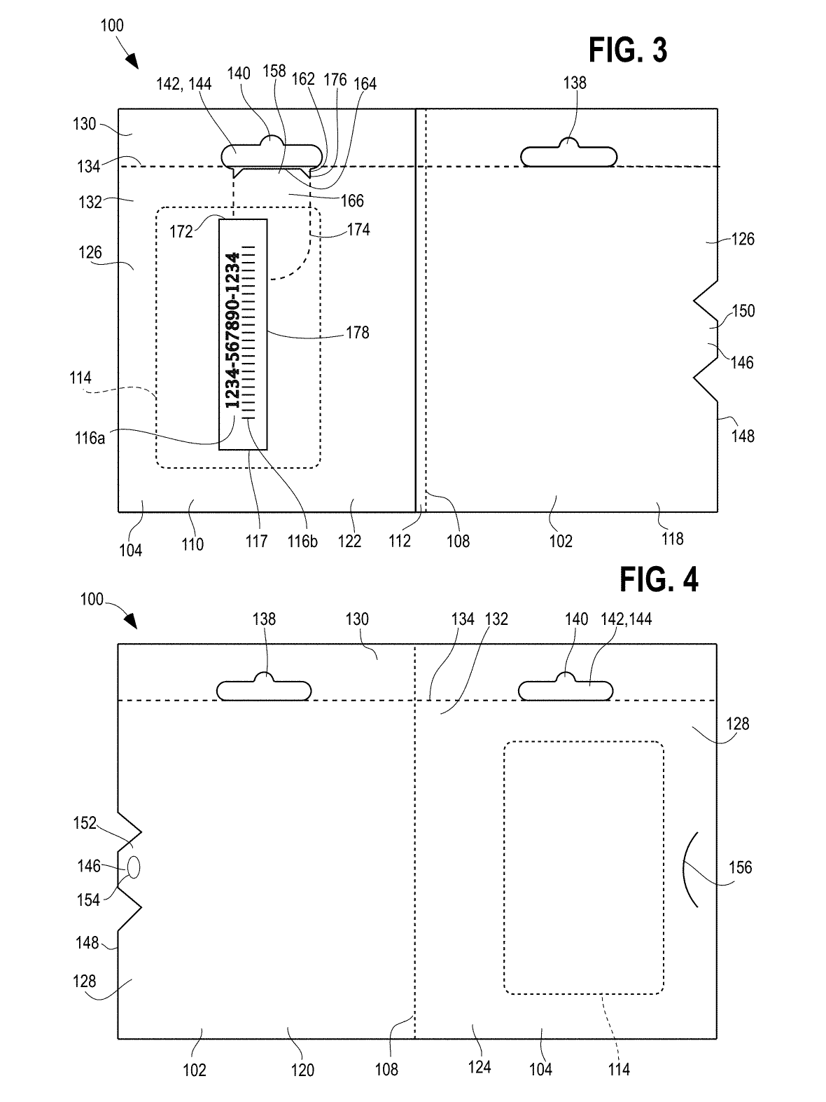

The front panel 102 includes an exterior surface 118 (FIG. 1) and an interior surface 120 (FIG. 4). The rear panel 104 includes an exterior surface 122 (FIG. 1) and an interior surface 124 (FIG. 4). The combination of the exterior surfaces 118 and 122 forms an exterior surface 126 (FIG. 3) of the carrier 100, and the combination of the interior surfaces 120 and 124 forms an interior surface 128 (FIG. 4) of the carrier 100.

One or more of the surfaces 118, 122, 120, and 124 may be imprinted using conventional printing processes including lithography, intaglio, flexography, foil transfer, ink jet, xerography, and the like. Such imprinting may be used to print an advertisement, a greeting, terms and conditions associated with the carrier 100 and/or gift card 114, and the like. In one embodiment, the exterior surface 118 is imprinted with a greeting, and the exterior surface 122 is imprinted with terms and conditions associated with the gift card 114.

The carrier 100 includes a top margin portion 130 separated from a body portion 132 by a line of weakness, for example, a perforated line 134. The line of weakness 134 may comprise another type of line of weakness such as a scored line, a fold, and the like apparent to those who have skill in the art. The perforated line 134 spans both the front panel 102 and the rear panel 104 of the carrier 100. In addition, in some embodiments, the perforations of the perforated line 134 span the distance between the exterior surface 126 to the interior surface 128 of the carrier 100. The carrier 100 further includes an orifice 136 disposed in the top margin portion 130. Such orifice 136 is formed by orifices 138 and 140 in the front panel 102 and the rear panel 104, respectively. The orifices 138 and 140 substantially or completely align with one another when the carrier is folded along the fold line 108.

Further, the orifice 140 in the rear panel 104 is formed by a first orifice 142 and a second orifice 144 in the first portion 110 and the second portion 112, respectively, that form the rear panel 104.

In a preferred embodiment, the orifice 136 has an elongate shape generally reminiscent of a sombrero. However, it should be apparent that such orifice 136 may have another shape including a circle, an oval, a polygon, or any other shape. Further, in a preferred embodiment, the orifices 138, 140, 142, and 144 all have substantially an identical shape. In other embodiments, one or more of these orifices 138, 140, 142, and 144 may have a shape that is different than that of the other of the orifices 138, 140, 142, and 144.

The front panel 102 of the carrier 100 includes a tab 146 formed along a side edge 148 thereof. The tab 146 includes an exterior surface 150 and an interior surface 152. In one embodiment, a fugitive glue 154 may be disposed on the interior surface 152 of the tab 146 so that when the carrier 100 is folded, the fugitive glue 154 releasably secures the tab 146 to the interior surface 124 of the rear panel 104. Securing the tab 146 to the interior surface 124 in this manner facilitates keeping the carrier 100 closed as shown in FIGS. 1 and 2.

Alternatively, in some embodiments, a pressure sensitive adhesive label or tape (not shown) may be applied proximate the edge 148 that contacts, for example, the surface 118 of the front panel 102 and at least one of the interior surface 124 and the exterior surface 122 of the rear panel 104, to hold the carrier 100 in the closed position. Other ways of the securing the front panel 102 of the carrier and the rear panel 104 apparent to those who have skill in the art may be used.

The interior surface 124 of the rear panel 104 includes a semicircular cutout 156. If the fugitive glue 154 is not used, has been removed (for example, after purchase), or is not sufficiently adhesive, the tab 146 may be inserted into the semicircular cutout 156 to facilitate keeping the carrier 100 in the closed position.

In a retail establishment, the carrier 100 may be displayed to customers by pendantly disposing the carrier 100 on a display rack (not shown) by, for example, passing a hook of such rack through the orifice 136. To purchase the carrier 100 and the gift card 114 disposed therein, a customer removes the carrier from the hook 100 and presents the carrier 100 to a cashier with appropriate payment. The cashier enters one or more of the indicia 116 into a point of sale system, for example, by scanning the barcode 116b to record sale of the carrier 100 and the gift card 114. In some embodiments, the point of sale system notifies the issuer (such as a store or a bank) of the gift card 114 that such card 114 has been sold, and in response the issuer activates the gift card 114.

After purchase, the customer may write or otherwise imprint a message on one or both of the exterior surface 118 of the front panel 102 and the exterior surface 122 of the rear panel 102. Further, the customer may release the tab 146 from the interior surface 124 of the rear panel 102 and open the carrier 100 to expose the interior surfaces 120 and 124 of the front and rear panels 102 and 104, respectively. The customer may then write or otherwise imprint a message on one or both of the interior surfaces 120 and 124.

Before presenting the carrier 100 and the gift card 114 to a recipient, the customer may wish to tear the carrier 100 along the perforated line 134 to separate the top margin portion 130 from the body portion 132, and present only the body portion 132 to the recipient. The body portion 132 without the top margin portion 130 is designed to resemble a greeting card with the gift card 114 disposed therein.

In one embodiment, the first portion 110 includes a tab 158 proximate the first orifice 142. Such tab portion 158 is formed by cutting or otherwise forming notches 160 and 162 in the first portion 110 that extend inwardly from a base 164 of the first orifice 142. The tab portion 158 forms a part of a removable section 166 that is bounded by a perforated line 168 extending from a vertex 170 of the notch 160 to a top edge 172 of the window 117. The removable section 166 is also bounded by a perforated curved segment 174 that extends from a vertex 176 of the notch 162 to a side edge 178 of the window 117. Pulling on the tab 158 causes the perforated line 168 and the curved segment 174 to tear, and thereby release the removable section 166 from the carrier 100. Releasing the removable section 166 in this manner creates a gap through which the gift card 114 can be urged outwardly from between the first portion 110 and the second portion 112 of the rear panel 104.

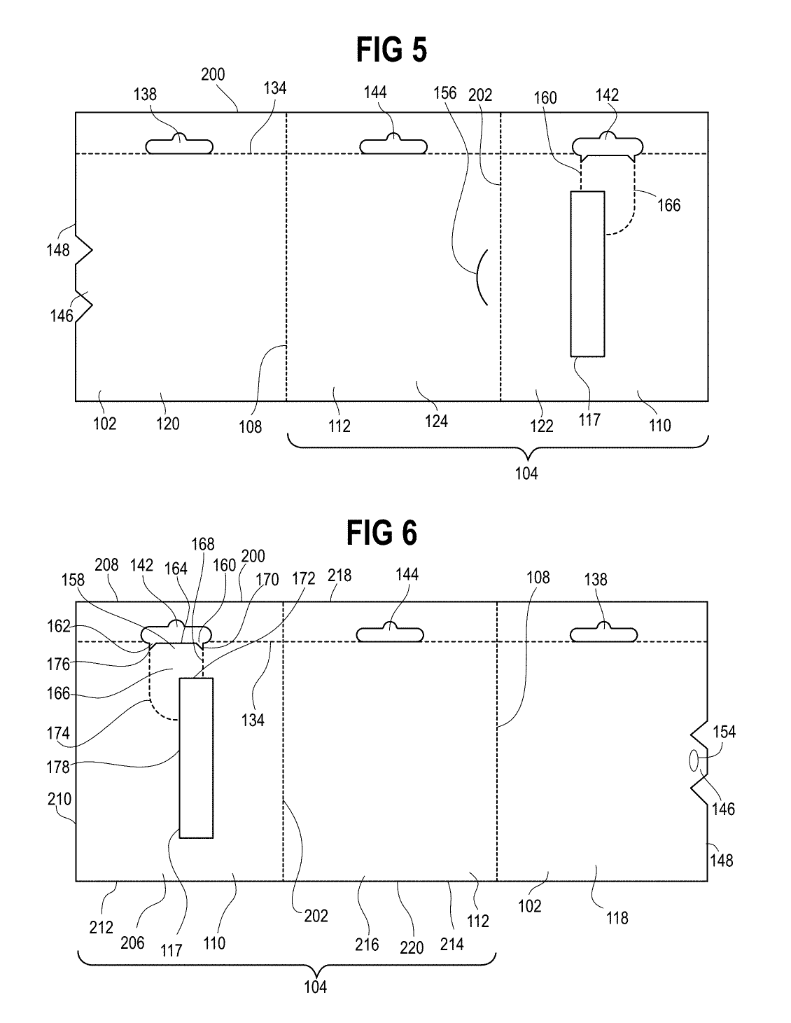

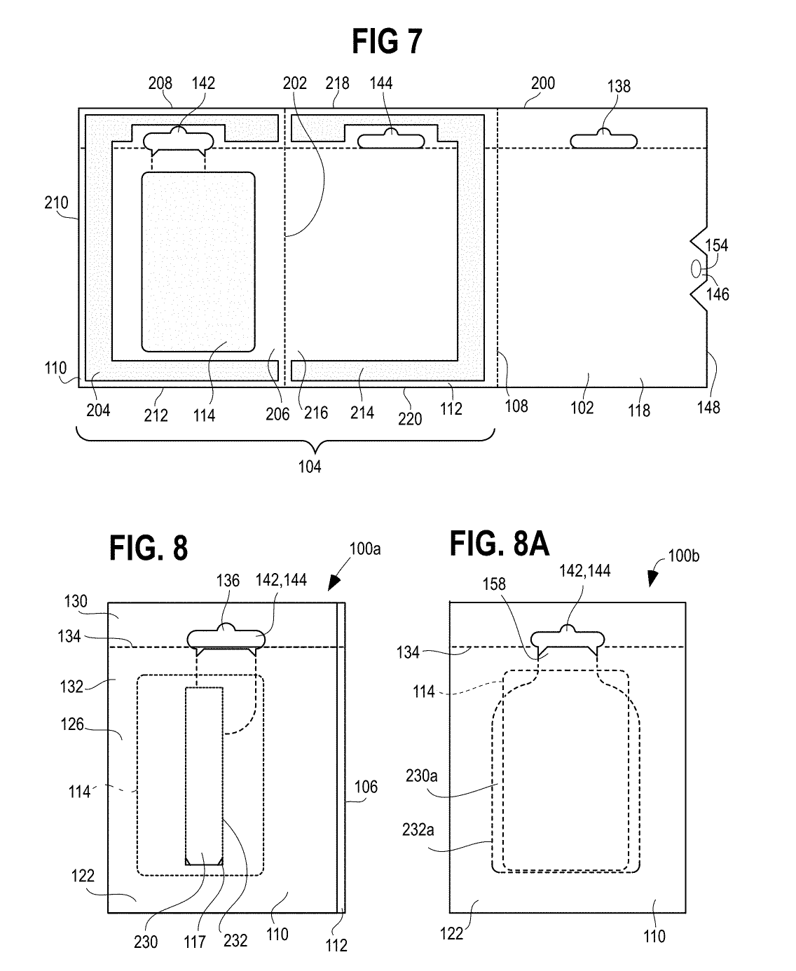

Referring to FIGS. 5-7, in one embodiment, the carrier 100 is manufactured from a single sheet of a substrate 200. The tab 146 is formed along the edge 148 of the substrate 100. In addition, the window 117, the orifices 138, 142, and 144, the tab portion 158 and the semicircular cut 156 are formed in the substrate, for example, by die cutting or by using one or more other cutting methods known to those of ordinary skill in the art. In addition, the perforated lines 134 and 168 and the perforated curved segment 174 are created in the substrate 200.

The first portion 110 of the rear panel 104 is separated from the second portion 112 of the rear panel 104 by a fold line 202. Adhesive is deposited in a margin region 204 of an inside surface 206 of the first portion 110. Such margin region 204 is proximate to outside edges 208, 210, and 212 of the first portion 110. Adhesive is also deposited in a margin region 214 of an inside surface 216 of the second portion 112. The margin region 214 is proximate to outside edges 218 and 220 of the second portion 112, and the fold line 108.

The gift card 114 is positioned on the first portion 110 such that the indicia 116 on the gift card 114 is aligned with the window 117. Thereafter, the substrate 200 is folded along the fold line 202 such that the adhesive in the margin region 204 is brought into contact with the adhesive in the margin region 214 to secure such margin regions 204 and 214 with one another, and thereby secure the gift card 114 between the first portion 110 and the second portion 112.

The substrate 200 may then be folded along the fold line 108 to form the folded carrier 110 shown in FIGS. 1 and 2.

In one embodiment, the distance between the edges 208 and 212 is approximately 5.25 inches, the distance between the edge 210 and the fold line 202 is approximately 3.9375 inches, the distance between the fold line 202 and the fold line 108 is approximately 4 inches, and the distance between the fold line 108 and the edge 148 is approximately 3.875 inches. Once folded, the carrier has dimensions of approximately 4 inches by approximately 5.25 inches. In another, embodiment, the carrier, when folded, has dimensions of approximately 3.625 inches by approximately 5 inches. It should be apparent that other embodiments of the carrier may have different dimensions, and, further, may not be rectangular.

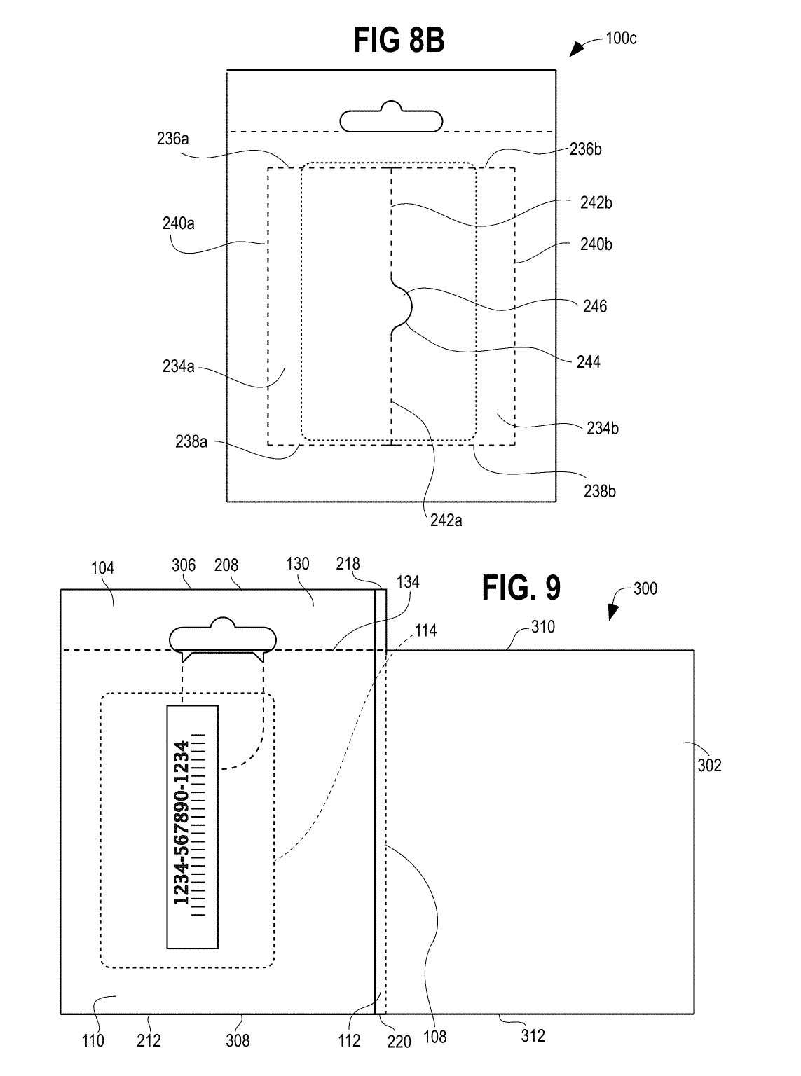

Referring to FIG. 8, in one embodiment, a carrier 100a is substantially identical to the carrier 100 described herein above, except a removable portion 230 is disposed where the window 117 is disposed in the rear panel 104 of the carrier 100. Removing the removable portion 230 forms the window 117 in the rear panel 104 and exposes through the window 117 the indicia 116 imprinted on the card 114. In use, the customer presents the carrier 100a with the removable portion 230 in place to the cashier, the cashier removes the removable portion to expose the indicia 116, and the cashier enters information in such indicia 116 into the point of sale system to activate the card 114. Because the removable portion 230 conceals the information in the indicia 116 until the carrier 110a is purchased, the card 114 may not be activated and/or used until after purchase.

In some embodiments, the removable portion 230 is formed by a line of weakness 232, such as a perforated line, that facilitates separation of the removable portion 230 from the rear panel 104. In other embodiments, the removable portion 230 may be formed by applying an opaque material on top of the indicia 116, such as, for example, a removable label or a scratch-off coating. Other ways of concealing the indicia 116 known to those who have skill in the art may be used.

Referring to FIG. 8A, a carrier 100b is substantially identical to the carrier 100 described herein above, except a separable portion 230a is disposed where the window 117 is disposed in the rear panel 104 of the carrier 100. The separable portion 230a is formed by a line of weakness 232a that is coupled to the tab portion 158 proximate the orifice 142. Pulling on the tab portion 158 facilitates tearing of the separable portion 230a along the line of weakness 232a, and removal of the separable portion 230a. In some embodiments, the removable portion 232a is sized and positioned on the rear panel 104, such that removing such portion 232a, for example by tearing, allows the item 114 to be removed from the carrier 100b.

Referring to FIG. 8B, a carrier 100c is substantially identical to the carrier 100 described herein above, except first and second separable portions 234a and 234b are disposed in the rear panel 104 instead of the window 117 and the carrier 100c does not include the tab 158. Each of the first and second separable portions 234 is formed by a first line of weakness 236 and a second line of weakness 238. The first and second lines of weakness 236 and 238 are coupled to one another by a third line of weakness 240. In addition, the first and second separable portions 234a and 234b are coupled to one another by fourth and fifth lines of weakness 242a and 242b. A cutout portion 244 is disposed between the fourth and fifth lines of weakness 242a and 242b to form a tab 246. Pulling on the tab 246 causes the rear panel to tear along the lines of weakness 242a, 242b, 236a, and 238b to separate the separable portion 234a from the rear panel 104. Thereafter, the separable portion 234b may be folded or torn along the third line of weakness 240a to form an aperture through which the item 114 may be accessed.

After the separable portion 234a has been separated from the rear panel 104, the separable portion 234b may also be separated therefrom by pulling on one or more of the lines of weakness 242 and the cutout 244 to tear the rear panel along the lines of weakness 236a and 236b. The second separable portion 234c may be folded or torn along the third line of weakness 240a to facilitate access and/or removal of the item 114 from the carrier 100.

As described in the foregoing, in some embodiments, accessing the item 114 requires tearing a portion of the carrier 100, and in particular the rear panel 104. In user, a purchaser, cashier, or other user may inspect such carrier 100 for tearing thereof to determine if the item 114 may have been tampered with or if the information on the item 114 may have been improperly accessed.

In at least those embodiments that do not include the window 117, the information that is necessary to activate the item is imprinted on one or both of the exterior surface 126 (FIG. 3) and the interior surface 128 (FIG. 4) of the carrier 100. The information imprinted on such surface(s) may be identical to or different from the information in the indicia 116 imprinted on the item 114. The cashier may use the information imprinted on one or both of the surfaces 126 and 128 to activate the item 114 when the carrier 100 is purchased, and the recipient of the item 114 may use the information in the indicia 116 to provide payment using the item 114.

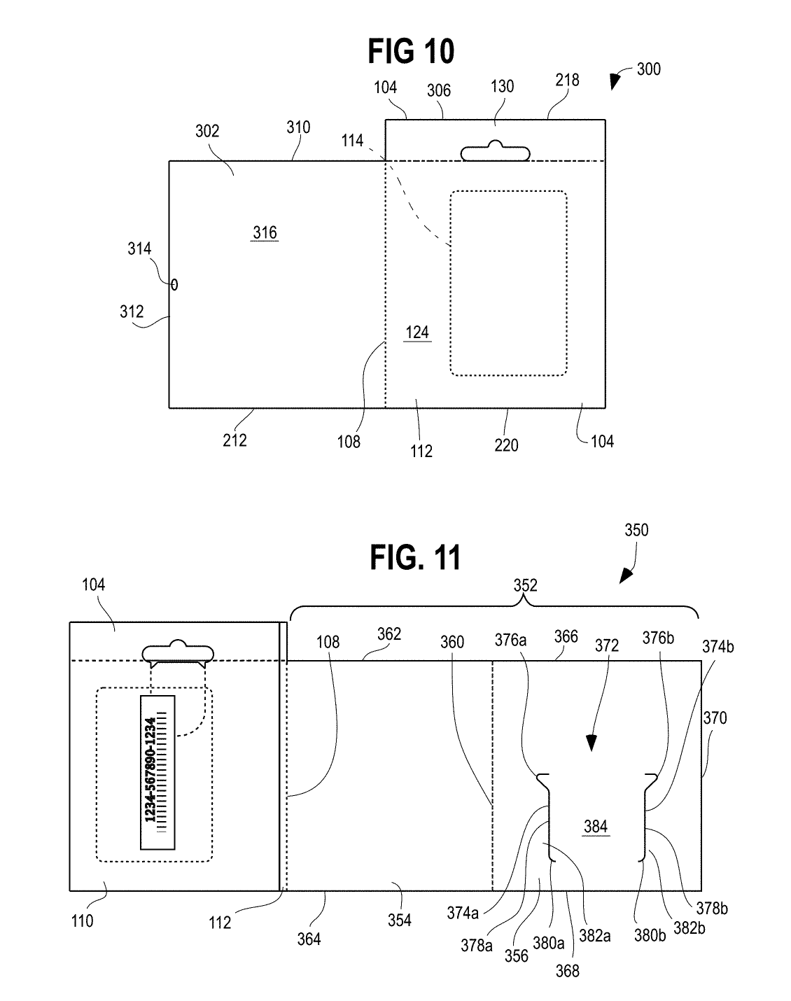

Referring to FIGS. 9 and 10, another embodiment of the combined item carrier and greeting card (carrier) 300 includes an item carrier 104 coupled to a greeting card 302 along a fold line or line of weakness 108. When the item carrier 104 and the greeting card 302 are folded toward one another along the line of weakness 108, the line of weakness 108 forms an outside edge of the carrier 300 (similar to the outside edge 106 of the carrier 100 shown in FIG. 1).

The greeting card 302 is similar to the greeting card 102 described above, except the greeting card 302 does not include a top margin portion 130, and hence the orifice 138. Rather, the top margin portion 130 of the carrier 300 only spans the item carrier 104.

The item carrier 104 includes a top edge 306 and a bottom edge 308 opposite one another. The top edge 306 is coextensive with one or both of the outside edges 208 and 218 of the first and second portions 110 and 112, respectively, that comprise the item carrier 104. The bottom edge 308 is coextensive with one or both of the outside edges 212 and 220 of the first and second portions 110 and 112. The greeting card 302 includes a top edge 310 and a bottom edge 312 opposite one another. In a preferred embodiment, the bottom edge 310 of the greeting card 302 is collinear with a bottom edge 312 of the item carrier 104.

The top margin portion 130 of the carrier 300 that spans the item carrier 104 is the region between the line of weakness 134 and top edge 306 of the item carrier 104. The top edge 310 of the greeting card 302 is substantially collinear with the line of weakness 134.

In some embodiments, the item carrier 104 may be free of the line of weakness 134. In such embodiments, the top margin portion 130 may be a portion of the item carrier 104 that extends upwardly (i.e., in a direction away from the bottom edge 308) beyond the edge 310 of the greeting card 302.

A fugitive glue may be deposited in a portion 314 of an interior surface 316 of the greeting card 302, proximate an outside edge 312 of the greeting card 302. When carrier 300 is folded along the line of weakness 314 such that the interior surface 316 contacts the interior surface 124 of the item carrier 104, the fugitive glue secures the greeting card 302 and the item carrier 104.

Alternatively, or in addition to the fugitive glue, a tab (not shown) may disposed along the outside edge 312 similar to the tab 146 shown in FIGS. 1-7. The tab (not shown) may be inserted into a cutout (not shown) formed in the item carrier 104, as shown in FIGS. 4 and 5, and described above.

Although the embodiments shown in FIGS. 1-10 contemplate a greeting card 102 that comprises one panel, it should be apparent that the combined greeting card and item carrier may comprise a greeting card having any number of panels.

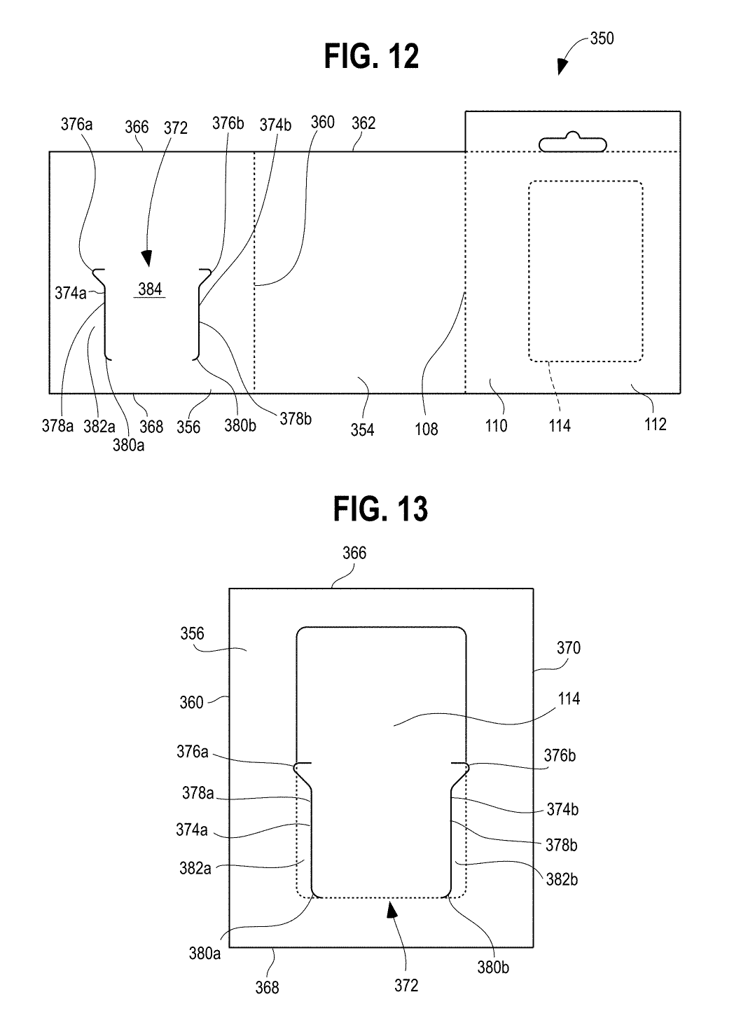

Referring to FIGS. 11 and 12, an embodiment of a carrier 350 includes an item carrier 104 coupled to a greeting card 352 along the line of weakness 108.

The greeting card 352 includes a first panel 354 and a second panel 356 coupled to one another along a further line of weakness 360. The first panel 354 includes opposite edges 362 and 364, the second panel includes opposite edges 366 and 368, and the second panel 356 also includes edge 370 substantially perpendicular to the edges 362-370. The greeting card 352 may include additional panels (not shown) that extend outwardly from the edges 362-370.

In some embodiments, the greeting card 352 includes an item holder 372 adapted to hold the item 114. In one embodiment, the item holder 372 comprises a first slit 374a and a second slit 374b. Each slit 374 includes a hook portion 376, and the hook portion 376 extends into a linear portion 378 that terminates in a curved portion 380. The slits 374a and 374b define flaps 382a and 382b, respectively, that are disposed along opposite edges of a central portion 384.

Referring to FIGS. 11-13, after the item 114 is removed from the item carrier 104, the item 114 may be inserted into the item holder 372 such that the item 114 is disposed between the flaps 382 and the central portion 384.

The greeting card 352 may be separated from item carrier 104 along the line of weakness 108. Thereafter, the greeting card 352, with the item 114 inserted into the item holder 372 may be presented to a recipient.

Referring FIGS. 1-13, it should be apparent, that although the item carrier 100 and the panel(s) of the greeting card 102, 302, and 352 are shown to have a rectangular shapes, one or more of such panels may have any other shape.

### INDUSTRIAL APPLICABILITY

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. A combined item carrier and greeting card, comprising:
a first panel including a first portion and second portion joined along a first line of weakness; and
a second panel joined to the first panel along a second line of weakness;
wherein the first portion and the second portion are secured to one another to form a package to hold an item therebetween.

2. The combined item carrier and greeting card of claim 1, wherein the second line of weakness is perforated to enable separation of the first panel from the second panel.

3. The combined item carrier and greeting card of claim 1, wherein the first panel includes a window adapted to expose a portion of the item therethrough.

4. The combined item carrier and greeting card of claim 1, wherein the first and second lines of weakness are parallel, further including a third line of weakness that spans the first panel and the second panel, wherein the third line of weakness is substantially perpendicular to the first and second lines of weakness.

5. The combined item carrier and greeting card of claim 4, wherein a first margin portion of the first panel is defined between the third line of weakness and an edge of the first panel, a second margin portion of the second panel is defined between the third line of weakness and an edge of second panel, and the first and second margin potions have first and second orifices, respectively, disposed therein.

6. The combined item carrier and greeting card of claim 5, wherein when the first panel is folded about the first line of weakness, the first and second orifices are substantially aligned.

7. The combined item carrier and greeting card of claim 1, further comprising a third panel joined to the second panel along a fourth line of weakness.

8. The combined item carrier and greeting card of claim 7, wherein the first panel includes a margin portion that extends in a direction substantially parallel to the first line of weakness beyond an edge of the second panel.

9. The combined item carrier and greeting card of claim 8, wherein an orifice is disposed in the margin portion.

10. The combined item carrier and greeting card of claim 7, wherein one of the second panel and the third panel includes an item holder.

11. The combined item carrier and greeting card of claim 1, wherein the first panel includes a tab formed along a side edge thereof and an adhesive disposed on the tab, wherein when the first panel is folded toward the second panel along the second line of weakness, the tab is releasably secured to the second panel.

12. The combined item carrier and greeting card of claim 1, wherein one of the first and the second portions includes a removable section, wherein separation of the removable section allows removal of the item from between the first and the second panels.

13. The combined item carrier and greeting card of claim 1, wherein the first panel and the second panel are manufactured from a single substrate.

14. The combined item carrier and greeting card of claim 1, wherein removal of the item from the item carrier requires tearing of the first panel.

15. A method of forming a combined item carrier and greeting card, comprising steps of:
forming a first panel comprising a first portion and a second portion in a substrate, the first and second portions joined along a first line of weakness;
forming a second panel in the substrate, the second panel joined to the first panel along a second line of weakness;
securing the first portion and the second portion to one another to form a package to hold an item therebetween.

16. The method of claim 15, including the further step of forming the second line of weakness by perforating the substrate.

17. The method of claim 15, including the further step of forming a window in the first panel adapted to expose a portion of the item therethrough.

18. The method of claim 15, wherein the first and second lines of weakness are parallel, including the further step of forming a third line of weakness that spans the first panel and the second panel, wherein the third line of weakness is substantially perpendicular to the first and second lines of weakness.

19. The method of claim 18, including the further steps of disposing a first orifice between the third line of weakness and an edge of the first panel, and disposing a second orifice between the third line of weakness and an edge of second panel.

20. The method of claim 19, including the further step of folding the first panel about the first line of weakness, wherein the step of folding the first panel comprises the step of aligning the first and second orifices.

21. The method of claim 15, further comprising the step of forming a third panel in the substrate, wherein the third panel is joined to the second panel along a fourth line of weakness.

22. The method of claim 21, comprising the first step of forming a margin portion in the first panel that extends beyond an edge of the second panel in a direction substantially parallel to the first line of weakness.

23. The method of claim 22, comprising the further step of disposing an orifice in the margin portion.

24. The method card of claim 21, including the further step of disposing an item holder in one of the second panel and the third panel.

25. The method of claim 15, including the further steps of forming a tab in the first panel along a side edge thereof, and disposing an adhesive on the tab, wherein when the first panel is folded toward the second panel along the second line of weakness, the tab is releasably secured to the second panel.

26. The method of claim 15, including the further step of forming a removable section in one of the first portion and the second portion, wherein separation of the removable section allows removal of the item from between the first and the second panels.

27. The method of claim 15, including the further step of requiring tearing of the first panel to remove the item from the item carrier requires tearing of the first panel.
